(19) United States
(12) Patent Application Publication
(10) Pub. No.: US 2020/0126022 A1
(43) Pub. Date: Apr. 23, 2020

(54) Automated Systems and Methods for Determining Jobs, Skills, and Training Recommendations

(71) Applicant: CareerBuilder, LLC, Chicago, IL (US)

(72) Inventors: Brian Gaspar, Los Gatos, CA (US); Khalifeh Aljadda, Suwanee, GA (US); Mohammed Korayem, Johns Creek, GA (US); Alan Chern, Sandy Springs, GA (US); Phuong Hoang, Duluth, GA (US); Robert Malony, Daytona Beach, FL (US); Kristen Ruel, Decatur, GA (US); Humair Ghauri, San Ramon, CA (US); Vachik S. Dave, Indianapolis, IN (US); Mohammad Al Hasan, Fishers, IN (US); Baichuan Zhang, Redwood City, CA (US); Mengshu Liu, Johns Creek, GA (US); Kareem Abdelfatah, Alpharetta, GA (US); Jingya Wang, Duluth, GA (US); Lamar Payson, North Chamblee, GA (US); Carl Eric Presley, Peachtree Corners, GA (US)

(21) Appl. No.: 16/528,467

(22) Filed: Jul. 31, 2019

Related U.S. Application Data
(60) Provisional application No. 62/748,265, filed on Oct. 19, 2018.
(60) Provisional application No. 62/786,720, filed on Dec. 31, 2018.
(60) Provisional application No. 62/861,592, filed on Jun. 14, 2019.

(51) Int. Cl. G06Q 10/06; G06Q 10/10; G06F 16/901; G06K 9/00

(52) U.S. Cl. CPC G06Q 10/063112; G06Q 10/1053; G06K 9/00463; G06K 9/00469; G06F 16/9024

(57) ABSTRACT

Automated systems and methods for determining jobs, skills, and training recommendations are disclosed. An example system includes one or more processors of an employment website entity. The one or more processors are configured to extract job information and skill information from resumes in a resume database, generate a job transition graph based on the job information, generate a job-skill graph based on the job information and the skill information, and generate a skill re-occurrence graph based on the skill information. The one or more processors are configured to determine a jobs matrix by minimizing an objective function based on the job transition graph, the job-skill graph, and the skill re-occurrence graph. The one or more processors are configured to retrieve next job recommendations from the jobs matrix based on a the current job position of a candidate and present, via an employment app, the next-job recommendations for the candidate.

### CROSS-REFERENCE RELATED APPLICATIONS

This application claims benefit of U.S. Provisional Patent Application No. 62/748,625, filed on Oct. 19, 2018; U.S. Provisional Patent Application No. 62/786,720, filed on Dec. 31, 2018; and U.S. Provisional Patent Application No. 62/861,592, filed on Jun. 14, 2019, all of which are hereby incorporated by reference in their entireties.

### TECHNICAL FIELD

The present disclosure generally relates to jobs recommendations and, more specifically, to automated systems and methods for determining jobs, skills, and training recommendations.

### BACKGROUND

Typically, employment websites (e.g., CareerBuilder.com®) are utilized by employers and job seekers. Oftentimes, an employment website incorporates a job board on which employers may post positions they are seeking to fill. In some instances, the job board enables an employer to include duties of a position and/or desired or required qualifications of job seekers for the position. Additionally, the employment website may enable a job seeker to search through positions posted on the job board. If the job seeker identifies a position of interest, the employment website may provide an application to the job seeker for the job seeker to fill out and submit to the employer via the employment website.

An employment website may provide assistance to job seekers looking for employment. For instance, the employment website may provide tips on navigating their website, advice on conducting interviews, example cover letters, resume templates, etc. Some job seekers potentially still may have difficulty in conducting the job seeking process due to its overwhelming nature. More generally, some job seekers potentially may be unsure as to what type of job he or she is looking for. For instance, some job seekers potentially may be unfamiliar with which type of jobs will lead the job seeker in advancing along his or her desired career path. Additionally or alternatively, some job seekers potentially may be unsure as to whether he or she is qualified and/or how to become qualified for a particular job that would advance his or her career.

### SUMMARY

The appended claims define this application. The present disclosure summarizes aspects of the embodiments and should not be used to limit the claims. Other implementations are contemplated in accordance with the techniques described herein, as will be apparent to one having ordinary skill in the art upon examination of the following drawings and detailed description, and these implementations are intended to be within the scope of this application.

Example embodiments are shown for automated systems and methods for determining jobs, skills, and training recommendations. An example disclosed system for determining recommendations for career paths includes one or more processors for an employment website entity. The one or more processors are configured to extract job information and skill information from resumes in a resume database and generate a job transition graph based on the job information. The job transition graph identifies likelihoods of transitioning between job positions. The one or more processors are configured to generate a job-skill graph based on the job information and the skill information. The job-skill graph identifies skills associated with the job positions. The one or more processors are configured to generate a skill re-occurrence graph based on the skill information. The skill re-occurrence graph identifies which of the skills are associated with each other. The one or more processors are configured to determine a jobs matrix by minimizing an objective function based on the job transition graph, the job-skill graph, and the skill re-occurrence graph. The jobs matrix identifies recommendation rankings of the job positions for career paths. The one or more processors are configured to store the jobs matrix in a jobs database and receive, via an employment app, a current job position of a candidate. The one or more processors are configured to retrieve next job recommendations from the jobs matrix based on the current job position and present, via the employment app, the next-job recommendations for the candidate.

In some examples, the one or more processors are configured to update the job transition graph, the job-skill graph, and the skill re-occurrence graph at intervals. In such examples, the one or more processors are configured to update the jobs matrix when the job transition graph, the job-skill graph, and the skill re-occurrence graph are updated.

In some examples, the objective function utilized by the one or more processors is a sigmoid function or a rectifier linear unit function. In some examples, the one or more processors are configured to minimize the objective function based on the job transition graph by minimizing the objective function based on affinity scores between the jobs, minimize the objective function based on the job-skill graph by minimizing the objective function based on affinity scores between the jobs and the skills, and minimize the objective function based on the skill re-occurrence graph by minimizing the objective function based on affinity scores between the skills.

In some examples, the one or more processors are configured to determine a skills matrix by minimizing the objective function based on the job transition graph, the job-skill graph, and the skill re-occurrence graph. In such examples, the skills matrix identifies recommendation rankings of the skills for the career paths. In such examples, the one or more processors are configured to store the skills matrix in a skills database. In some such examples, the one or more processors are configured to retrieve skills recommendations to facilitate the candidate in transitioning from the current job position to the next-job recommendations and present, via the employment app, the skills recommendations for the candidate. In some such further examples, the one or more processors minimize the objective function to jointly learn the recommendation rankings of the jobs and the recommendation rankings of the skills in a shared k-dimensional space to increase a relevancy of the next-job recommendations and the skill recommendations for the candidate. In some such further examples, the one or more processors are configured to receive a selection of one of the skills recommendations from the candidate via the employment app, retrieve a training activity from a training database based on the selected one of the skills recommendations, and perform the training activity that corresponds with the selected one of the skills recommendations. Moreover, in some such further examples, the one or more processors are configured to present a quiz to the candidate via the employment app after the training activity has been completed. Additionally, in some such further examples, the one or more processors are configured to generate a skills addendum to a resume of the candidate in response to the candidate passing the quiz.

Another example disclosed system for determining recommendations for career paths includes one or more processors for an employment website entity. The one or more processors are configured to extract job information and skill information from resumes in a resume database and generate a job transition graph based on the job information. The job transition graph identifies likelihoods of transitioning between job titles. The one or more processors are configured to generate a job-skill graph based on the job information and the skill information. The job-skill graph identifies skills associated with the job titles. The one or more processors are configured to generate a skill re-occurrence graph based on the skill information. The skill re-occurrence graph identifies which of the skills are associated with each other. The one or more processors are configured to determine a jobs matrix and a skills matrix by minimizing an objective function based on the job transition graph, the job-skill graph, and the skill re-occurrence graph. The jobs matrix identifies recommendation rankings of the job titles for career paths, and the skills matrix identifies recommendation rankings of the skills for the career paths. The one or more processors are configured to determine a postings matrix based on the jobs matrix and the skills matrix. The postings matrix identifies recommendation rankings of job postings for the career paths. The one or more processors are configured to store the postings matrix in a postings recommendation database and receive, via an employment app, a current job position of a candidate. The one or more processors are configured to retrieve the posting recommendations from the postings matrix based on the current job position and present, via the employment app, the posting recommendations for the candidate.

In some examples, the one or more processors are configured to update the job transition graph, the job-skill graph, and the skill re-occurrence graph at intervals. In such examples, the one or more processors are configured to update the jobs matrix, the skills matrix, and the postings matrix when the job transition graph, the job-skill graph, and the skill re-occurrence graph are updated.

In some examples, the objective function utilized by the one or more processors is a sigmoid function or a rectifier linear unit function. In some examples, the one or more processors are configured to at least one of minimize the objective function based on the job transition graph by minimizing the objective function based on affinity scores between the job titles, minimize the objective function based on the job-skill graph by minimizing the objective function based on affinity scores between the job titles and the skills, and minimize the objective function based on the skill re-occurrence graph by minimizing the objective function based on affinity scores between the skills.

In some examples, the one or more processors are configured to store the skills matrix in a skills database, retrieve skills recommendations to facilitate the candidate in transitioning from the current job position to the posting recommendations, and present, via the employment app, the skills recommendations for the candidate. In some such examples, the one or more processors are configured to minimize the objective function to jointly learn the recommendation rankings of the job titles and the recommendation rankings of the skills in a shared k-dimensional space to increase a relevancy of recommendations for the candidate. In some such examples, the one or more processors are configured to receive a selection of one of the skills recommendations from the candidate via the employment app, retrieve a training activity from a training database based on the selected one of the skills recommendations, and perform the training activity that corresponds with the selected one of the skills recommendations. In some such examples, the one or more processors are configured to present a quiz to the candidate via the employment app after the training activity has been completed and generate a skills addendum to a resume of the candidate in response to the candidate passing the quiz.

In some examples, to determine the postings matrix based on the jobs matrix and the skills matrix, the one or more processors are configured to retrofit the jobs matrix and the skills matrix together such that each job title vector within the jobs matrix is modified by one or more corresponding skills vectors within the skills matrix.

In some examples, the one or more processors are configured to determine a personalized location matrix for the candidate that identifies relative distances between locations associated with the job postings and an address of the candidate, personalize the postings matrix for the candidate by concatenating the location matrix with the postings matrix, and retrieve the posting recommendations for the candidate upon personalizing the postings matrix for the candidate.

### BRIEF DESCRIPTION OF THE DRAWINGS

For a better understanding of the invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further, in the drawings, like reference numerals designate corresponding parts throughout the several views.

FIG. 1 illustrates an example environment in which an employment website entity presents job, skill, and training recommendations to a job seeker via an employment app in accordance with the teachings herein.

FIG. 2 is a block diagram of components the employment website entity of FIG. 1 for determining and presenting job, skill, and training recommendations.

FIG. 3 is a block diagram of electronic components of the employment website entity of FIG. 1.

FIG. 4 illustrates an example interface of the employment app of FIG. 1 in a first state.

FIG. 5 illustrates the interface of FIG. 4 in a second state.

FIG. 6 illustrates another example interface of the employment app of FIG. 1 in a first state.

FIG. 7 illustrates the interface of FIG. 6 in a second state.

FIG. 8 illustrates another example interface of the employment app of FIG. 1.

FIG. 9 illustrates another example interface of the employment app of FIG. 1.

FIG. 10 illustrates another example interface of the employment app of FIG. 1.

FIG. 11 illustrates another example interface of the employment app of FIG. 1.

FIG. 12 illustrates another example interface of the employment app of FIG. 1.

FIG. 13 illustrates another example interface of the employment app of FIG. 1.

FIGS. 14A-14C depict a flowchart for determining and presenting job, skill, and training recommendations for a job seeker in accordance with the teachings herein.

### DETAILED DESCRIPTION OF EXAMPLE EMBODIMENTS

While the invention may be embodied in various forms, there are shown in the drawings, and will hereinafter be described, some exemplary and non-limiting embodiments, with the understanding that the present disclosure is to be considered an exemplification of the invention and is not intended to limit the invention to the specific embodiments illustrated.

The example systems and methods disclosed herein provide jobs and skills recommendations for a career path of a job seeker based on his or her current job by determining recommendation rankings of job titles, job postings, and skills in a shared k-dimensional space of jobs. Examples disclosed herein recommend job titles associated with current and previous job postings on an employment website (e.g., customer service manager). Further, examples disclosed herein recommend job postings that are currently posted on an employment website by recruiters for particular positions of employers (e.g., Customer Service Manager at the Apple Store location in Mishawaka, Ind.).

For example, the systems and methods disclosed herein determine the job titles and skills recommendations for the job seeker by (1) extracting job title and skill information from a database of resumes; (2) generating (i) a job transition graph that identifies relationships between job titles, (ii) a job-skill graph that identifies relationships between job titles and skills, and (iii) a skill re-occurrence graph that identifies relationships between skills based on the extracted information; (3) determining (i) a jobs matrix that includes recommendation rankings of job titles and (ii) a skills matrix that includes recommendation rankings of skills by minimizing an objective function based on the generated graphs; and (4) retrieving (i) recommended next-job titles for a career path from the jobs matrix and (ii) corresponding recommended skills from the skills matrix based on the current job of the job seeker.

Additionally or alternatively, the systems and methods disclosed herein determine the job postings and skills recommendations for the job seeker by (1) extracting job title and skill information from a database of resumes; (2) generating (i) a job transition graph that identifies relationships between job titles, (ii) a job-skill graph that identifies relationships between job titles and skills, and (iii) a skill re-occurrence graph that identifies relationships between skills based on the extracted information; (3) determining (i) a jobs matrix that includes recommendation rankings of job titles and (ii) a skills matrix that includes recommendation rankings of skills by minimizing an objective function based on the generated graphs; (4) determining a postings matrix by retrofitting the jobs matrix and the skills matrix together such that each job title vector within the jobs matrix is modified by one or more corresponding skills vectors within the skills matrix; and (5) retrieving (i) recommended job postings for a career path from the postings matrix and (ii) corresponding recommended skills from the skills matrix based on the current job of the job seeker.

Further, the systems and methods disclosed herein guide the job seeker along his or her career path by (a) presenting the recommended next-job titles or postings and the corresponding recommended skills to the job seeker, (b) presenting training activities that enable the job seeker to obtain a recommended skill for a recommended next-job title or posting, (c) quizzing the job seeker on the training activities to verify that the job seeker has obtained the recommended skill, and (d) generating a skills addendum for a resume of the job seeker to show that the job seeker has obtained the recommended skill.

Thus, the examples disclosed herein include a specific set of rules that provide an improved technological result of accurately generating recommended next jobs, skills, and training activities for a job seeker in an automated manner to solve the problem of providing career path guidance to the job seeker, on-demand and in real-time, based on recent employment data. Further, the examples disclosed herein include an ordered combination of non-conventional arrangement of pieces that form a particular, practical application for the automated generation of recommended next jobs, skills, and training activities for a career path of a job seeker.

Further, the examples disclosed herein include improved user interfaces for computing devices that are particularly structured to present recommended jobs, skills, and training activities in an easy-to-follow, time-efficient manner for a job seeker. For instance, some of the example interfaces disclosed herein are specifically configured to facilitate the presentation of recommended jobs, skills, and training activities on small screens of mobile devices (e.g., smart phones, tablets, etc.), which are being used more-and-more over time as a primary computing device. Those interfaces are configured to enable a job seeker to utilize a mobile device to quickly (1) identify a potential next-job title or posting, (2) view recommended skills for that job title or posting, (3) perform a training activity for a recommended skill, and (4) take a quiz to confirm obtainment of the recommended skill, while the job seeker is on-the-go. Thus, the examples disclosed herein improve the usability of a computing device by including interfaces that are specifically configured to present recommended jobs, skills, and training activities to facilitate a job-seeker in identifying and becoming qualified for a next-job title or posting in his or her career path.

As used herein, an “employment website entity” refers to an entity that operates and/or owns an employment website and/or an employment app. As used herein, an “employment website” refers to a website and/or any other online service that facilitates job placement, career, and/or hiring searches. Example employment websites include CareerBuilder.com®, Sologig.com®, etc. As used herein, an “employment app” and an “employment application” refer to a process of an employment website entity that is executed on a mobile device, a desktop computer, and/or within an Internet browser of a candidate. For example, an employment application includes a mobile app that is configured to operate on a mobile device (e.g., a smart phone, a smart watch, a wearable, a tablet, etc.), a desktop application that is configured to operate on a desktop computer, and/or a web application that is configured to operate within an Internet browser (e.g., a mobile-friendly website configured to be presented via a touchscreen of a mobile device).

As used herein, a “candidate” and a “job seeker” refer to a person who is searching for a job, position, and/or career. As used herein, a “recruiter” refers to a person and/or entity (e.g., a company, a corporation, etc.) that solicits one or more candidates to apply for a position and/or a job. For example, a recruiter may include an employer, an employee and/or other representative (e.g., a human resources representative, etc.) of an employer, and/or third-party headhunter.

As used herein, “real-time” refers to a time period that is simultaneous to and/or immediately after a candidate enters a keyword into an employment website. For example, real-time includes a time duration before a session of the candidate with an employment app ends. As used herein, a “session” refers to an interaction between a job seeker and an employment app. Typically, a session will be relatively continuous from a start point to an end point. For example, a session may begin when the candidate opens and/or logs onto the employment website and may end when the candidate closes and/or logs off of the employment website.

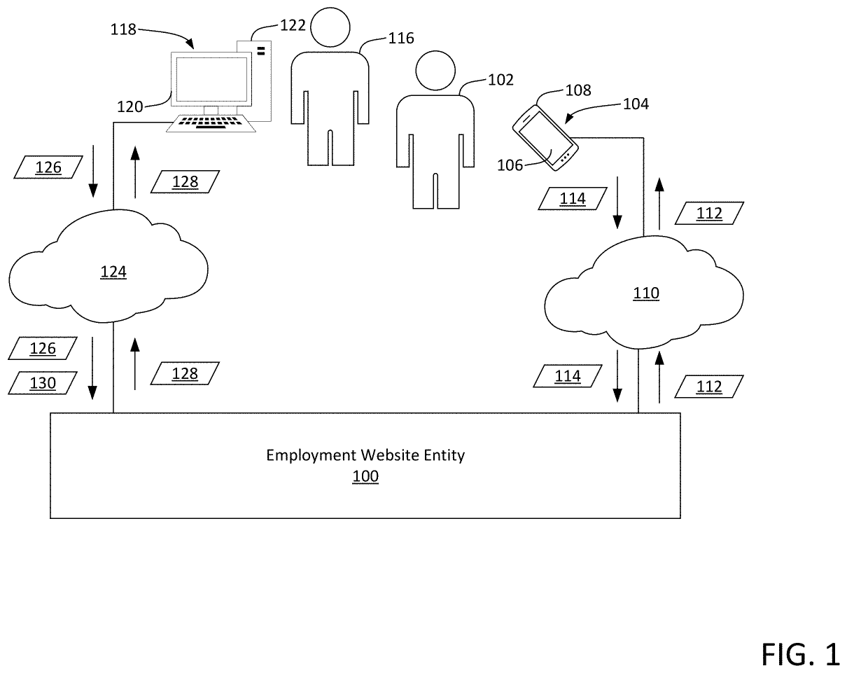

Turning to the figures, FIG. 1 illustrates an example employment website entity 100 (e.g., CareerBuilder.com®) that enables presentation of employment opportunities and submits applications for a candidate 102 via an employment app 104 in accordance with the teachings herein. In the illustrated example, a touchscreen 106 of a mobile device 108 (e.g., a smartphone, a tablet, etc.) presents the employment app 104. For example, the touchscreen 106 is (1) an output device that presents interfaces of the employment app 104 to the candidate 102 and (2) an input device that enables the candidate 102 to input information by touching the touchscreen 106. Additionally or alternatively, the employment app 104 is configured to be presented via a touchscreen of a stationary computing device and/or a non-touch display of a computing device (e.g., a desktop, a laptop, a mobile device, etc.). Further, in some examples, the computing device is configured to receive information from the candidate 102 via other input device(s) (e.g., a button, a keyboard, a mouse, voice command, etc.). In the illustrated example, the candidate 102 interacts with the employment app 104 during a session of the candidate 102 on the employment app 104.

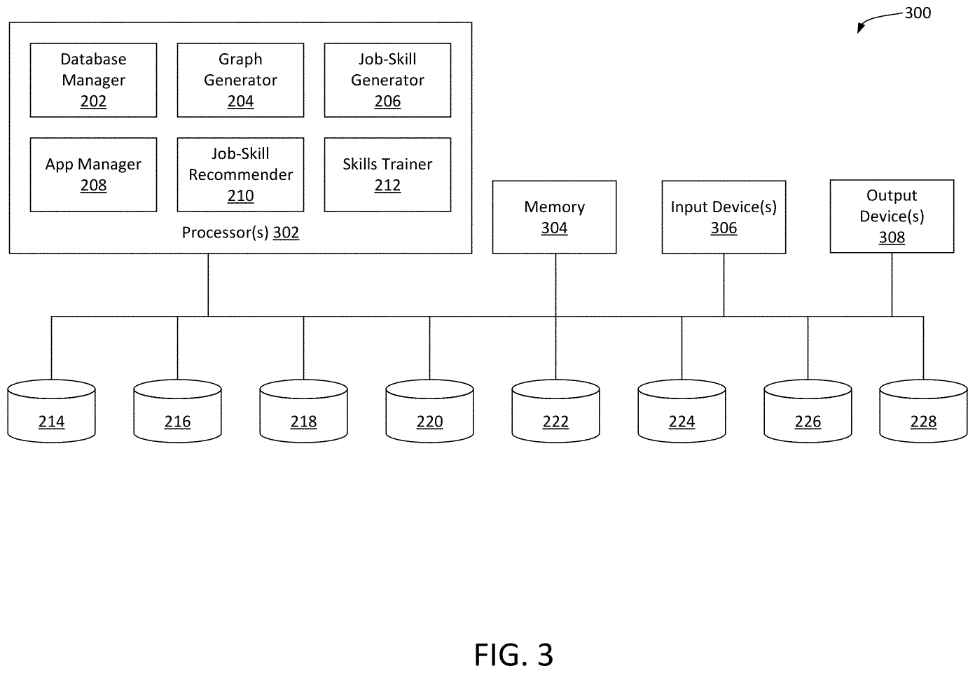

As illustrated in FIG. 1, the mobile device 108 of the candidate 102 and one or more processor(s) of the employment website entity 100 (e.g., one or more processors 302 of FIG. 3) are in communication with each other via a network 110 (e.g., via a wired and/or a wireless connection). The network 110 may be a public network, such as the Internet; a private network, such as an intranet; or combinations thereof. In the illustrated example, the processor(s) of the employment website entity 100 sends app data 112 (e.g., interfaces of the employment app 104, recommended next-job title and/or postings, recommended skills, recommended training activities, etc.) that are presented to the candidate 102 via the touchscreen 106 of the mobile device 108. Further, the processor(s) of the employment website entity 100 collect candidate data 114 (e.g., contact information, a current job, etc.) that the candidate 102 provides via the employment app 104.

Additionally, the employment website entity 100 of the illustrated example enables presentation of potential candidates, candidate information, and/or other information to a recruiter 116 via an employment website and/or app 118. For example, a display 120 (e.g., a touchscreen, a non-touch display, etc.) of a computing device 122 (e.g., a computer, a desktop, a laptop, a mobile device, a tablet, etc.) presents interface(s) of the employment website and/or app 118 to the recruiter 116. Further, the employment website entity 100 of the illustrated example enables collection of employment postings, employer preferences, and/or other information from the recruiter 116 via the employment website and/or app 118. For example, the computing device 122 include input device(s) (e.g., a touchscreen, a keyboard, a mouse, a button, a microphone, etc.) that enable the recruiter 116 to input information for the employment website and/or app 118 via the computing device 122.

As illustrated in FIG. 1, the computing device 122 of the recruiter 116 and the processor(s) of the employment website entity 100 are in communication (e.g., via a wired and/or a wireless connection) with each other via a network 124. The network 124 may be a public network, such as the Internet; a private network, such as an intranet; or combinations thereof. In the illustrated example, the network 124 is separate from the network 110. In other examples, the network 124 and the network 110 are integrally formed. Further, the processor(s) of the employment website entity 100 collect recruitment data 126 (e.g., employment postings, user selections, etc.) that the recruiter 116 provides via the employment website and/or app 118. Further, in the illustrated example, the processor(s) of the employment website entity 100 sends recruitment data 126 (e.g., interfaces of the employment website and/or app 118, candidate information, etc.) that are presented to the recruiter 116 via the display 120 of the computing device 122.

Further, the processor(s) of the employment website entity 100 are configured to collect historical data 130 that includes resumes. In the illustrated example, the processor(s) collect the historical data 130 via the network 124. Additionally or alternatively, the processor(s) collect the historical data 130 via the network 110 and/or any other network. For example, the processor(s) collect resumes previously submitted via the employment app 104, via another employment app and/or website of the employment website entity 100, and/or via other app(s) and/or website(s) with employment postings.

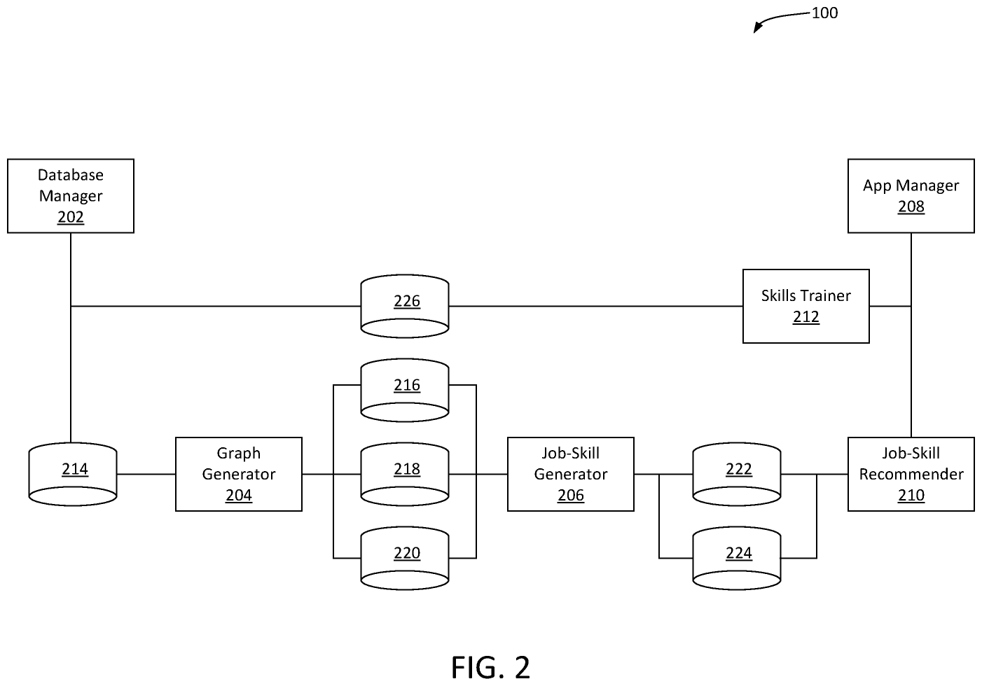

FIG. 2 is a block diagram of components of one or more processors (e.g., processor(s) 302 of FIG. 3) of the employment website entity 100 for determining and presenting job, skill, and training activity recommendations to the candidate 102. As illustrated in FIG. 2, the components of the employment website entity 100 include a database manager 202, a graph generator 204, a job-skill generator 206, an app manager 208, a job-skill recommender 210, and a skills trainer 212. Further, in the illustrated example, the components of the employment website entity 100 include a resume database 214, a job transition database 216, a job-skill database 218, a skill re-occurrence database 220, a jobs recommendation database 222, a skills recommendation database 224, a training database 226, and a postings recommendation database 228.

In operation, the database manager 202 collects previously-submitted resumes. For example, the database manager 202 collects the resumes via the network 124. Additionally or alternatively, the database manager 202 collects the resumes via the network 110. For example, the database manager 202 collects resumes previously submitted via the employment app 104, via another employment app and/or website of the employment website entity 100, and/or via other app(s) and/or website(s) with employment postings. In some examples, the database manager 202 performs web scraping to collect historical resumes from one or more internal networks (e.g., a network of the employment website entity 100) and/or external networks (e.g., the Internet). Further, upon collecting historical resumes via scraping, the database manager 202 normalizes and/or cleans the scraped resumes to remove unrelated noise from the documents. Additionally, the database manager 202 of the illustrated example stores the resumes in the resume database 214 upon collecting the resumes.

The graph generator 204 of the illustrated example extracts job information and skill information from the resumes stored in the resume database 214. For example, the job information includes characteristics of jobs (e.g., title, salary, employer, location, etc.), and the skill information includes types of skills (e.g., negotiation skills, planning skills, software proficiencies, etc.) that correspond with the jobs and/or job seekers corresponding with the resumes. For example, upon retrieving the resumes from the resume database 214, the graph generator 204 utilizes text mining software to extract the job information and the skill information from the resumes.

Additionally, the graph generator 204 of the illustrated example generates a job transition graph (also referred to as a job transition network), a job-skill graph (also referred to as a job-skill network), and a skill re-occurrence graph (also referred to as a skill re-occurrence network) based on the job and skill information extracted from the stored resumes. For example, the graph generator 204 generates (i) the job transition graph based on the extracted job information, (ii) the job-skill graph based on the extracted job and skill information, and (iii) the skill re-occurrence graph based on the extracted skill information. Further, the graph generator 204 stores (i) the job transition graph in the job transition database 216, (ii) the job-skill graph in the job-skill database 218, and (iii) the skill re-occurrence graph in the skill re-occurrence database 220.

The job transition graph identifies how likely job seekers are in transitioning between particular job titles. For example, the job transition graph is represented as G^{jj}(T, E^{j}, W^{j}), in which T represents a set of job titles and E′ represents a set of directed edges from a source (e.g., one job title) to a target (e.g., another job title) that represent people transitioning from the source job title to the target job title. The job-skill graph identifies how skills are associated with the job positions. For example, the job-skill graph is represented as G^{js}(T∪S, E^{js}), in which T represents a set of job titles, S represents a set of skills with number of skills n^{s}=|S|, and E^{js} represents a set of edges from a job title to a skill that represents whether the job title requires the corresponding skill. Further, the skill re-occurrence graph identifies which of the skills are associated with each other. For example, the skill re-occurrence graph is represented by G^{ss}(S, E^{s}, W^{s}), in which S represents a set of skills and E^{s} represents a set of directed edges from one skill to another.

In the illustrated example, the graph generator 204 is configured to update the job transition graph, the job-skill graph, and the skill re-occurrence graph over time. For example, the graph generator 204 updates the graphs intermittently, at predefined intervals (e.g., once a day, once of month, etc.), and/or at predefined events (e.g., upon collecting a predefined x-number (e.g., 100, 1000, etc.) of new resumes) to ensure that career path recommendations are being provided to the candidate 102 and/or other job seekers based on up-to-date employment data.

The job-skill generator 206 of the illustrated example jointly and/or simultaneously generates a jobs matrix and a skills matrix that enable career path recommendations to be provided to the candidate 102 and/or other job seekers. The jobs matrix includes job similarity information that indicates how similar job titles are with respect to each other. For example, the jobs matrix identifies recommendation rankings of job titles that quantitatively indicate to what extent job titles correspond with others within a career path. Further, the skills matrix includes skill similarity information that indicates how similar skills are with respect to each other. For example, the skills matrix identifies recommendation rankings of skills that quantitatively indicate how some skills correspond with other skills and/or with job titles within a career path. The recommendation rankings include individual ranks and/or ranking groups. For example, the recommendation rankings include individual ranks, such as a 1st highest rank, a 2nd highest rank, a 3rd highest rank, etc. Additionally or alternatively, the recommendation rankings include ranking groups such as tertiles, quartiles, quintiles, etc.

In the illustrated example, the job-skill generator 206 utilizes a representation learning model to jointly determine the job similarity information of the jobs matrix and the skill similarity information of the skills matrix in a single, shared k-dimensional latent space based on the job transition graph, the job-skill graph, and the skill re-occurrence graph. That is, the job-skill generator 206 assimilates signals from multiple sources (e.g., the job transition graph, the job-skill graph, and the skill re-occurrence graph) to generate yield latent vectors of job positions and skills such that (1) a dot product between a job vector of a job title and a skill vector of a skill identifies a relevance of the skill to the job title and (2) a dot product between skill vectors of two respective skills identifies a similarity between the two skills. By utilizing such a process, the job-skill generator 206 considers more intricate relationships between job titles and skills and, thus, more accurately determines job titles and skills recommendations that are relevant to the career paths of the candidate 102 and/or other job seekers.

The job-skill generator 206 of the illustrated example is configured to utilize a Bayesian personalized ranking and/or a margin-based loss function to determine the jobs matrix and the skills matrix based on the job transition graph, the job-skill graph, and the skill re-occurrence graph. That is, the job-skill generator 206 of the illustrated example utilizes a rectifier linear unit (ReLU) function, represented by ReLU(v)=max(0, v), and/or a sigmoid function, represented by

$$σ ( v ) = \frac{1}{1 + {e}^{- v}} ,$$

to jointly determine the jobs matrix and the skills matrix. For example, to determine the jobs matrix and the skills matrix, the job-skill generator 206 minimizes an objective function (e.g., a sigmoid function, a ReLU function) based on, at least in part, the job transition graph, the job-skill graph, and the skill re-occurrence graph. An example sigmoid objective function utilized by the job-skill generator 206 to determine the jobs matrix and the skills matrix is provided below:

$$O ( W , {W}^{′} ) = {min}_{{WW}^{′}} {O}^{jj} + {O}^{js} + {O}^{ss} + λ \cdot ( {‖ W ‖}_{F}^{2} + {‖ {W}^{′} ‖}_{F}^{2} ) \qquad Equation 1$$

In Equation 1, O represents the objective function that is minimized. Further, W represents the jobs matrix and W′ represents the skills matrix, which are jointly determined by the job-skill generator 206 by minimizing Equation 1. For example, the jobs matrix is represented by Equation 2 and the skills matrix is represented by Equation 3 provided below:

W=[w₁^{T},w₂^{T}, . . . ,wₙ_{^{j}}^{T}]^{T}∈Rⁿ^{^{j×k}} Equation 2

W=[w′₁^{T},w′₂^{T}, . . . ,w′ₙ_{^{j}}^{T}]^{T}∈Rⁿ^{^{5×k}} Equation 3

In Equation 2, W represents the jobs matrix and wⁱ represents the i^{th} job title. In Equation 3, W′ represents the skills matrix and W′ⁱ represents the i^{th} skill.

Further, returning to Equation 1, ∥W∥_{F}² represents a regularization of the jobs matrix to avoid over-fitting, ∥W′∥_{F}² represents a regularization of the skills matrix to avoid over-fitting, represents a regularization co-parameter. Additionally, O^{jj} represents an objective function that is minimized and corresponds with the job transition graph, O^{js} represents an objective function that is minimized and corresponds with the job-skill graph, and O^{ss} represents an objective function that is minimized and corresponds with the skill re-occurrence graph. For example, O^{jj}, O^{ss}, and O^{js} are represented by Equation 4, Equation 5, and Equation 6, respectively, provided below:

$$\begin{matrix}{O}^{jj} = {min}_{W} - {\sum }_{( x , y , z ) ϵ {D}^{jj}} ln σ ( 〈 {w}_{x} , {w}_{y} 〉 - 〈 {w}_{x} , {w}_{z} 〉 ) & Equation 4 \\ {O}^{ss} = {min}_{{W}^{′}} - {\sum }_{( x , y , z ) ϵ {D}^{ss}} ln σ ( 〈 {w}_{x}^{′} , {w}_{y}^{′} 〉 - 〈 {w}_{x}^{′} , {w}_{z}^{′} 〉 ) & Equation 5 \\ {O}^{js} = {min}_{{WW}^{′}} - {\sum }_{( {x}^{j} , {y}^{s} , {z}^{s} ) ϵ {D}^{js}} ln σ ( 〈 {w}_{{x}^{j}} , {w}_{{y}^{s}}^{′} 〉 - 〈 {w}_{{x}^{j}} , {w}_{{z}^{s}}^{′} 〉 ) & Equation 6\end{matrix}$$

With respect to Equation 4, O^{jj} represents an objective function that is minimized and corresponds with the job transition graph. Further, D^{jj} represents a set of training triplets sampled from the job transition graph, G^{jj}. [symbol] wₓ,w_{y} [symbol] represents an affinity score between a first job title, wₓ, and a second job title, w_{y}. [symbol] wₓ, w_{z} [symbol] represents an affinity score between the first job title, wₓ, and a third job title, w_{z}. Thus, to minimize the objective function of Equation 1 based on the job transition graph, the job-skill generator 206 minimizes the objective function based on affinity scores between job titles identified in the job transition graph.

With respect to Equation 5, O^{ss} represents an objective function that is minimized and corresponds with the skill re-occurrence graph. Further, D^{ss} represents a set of training triplets sampled from the skill re-occurrence graph, G^{ss}. [symbol] wₓ′,w_{y}′ [symbol] represents an affinity score between a first skill, wₓ′, and a second skill, w_{y}′. [symbol] wₓ′,w_{z}′ [symbol] represents an affinity score between the first skill, wₓ′, and a third skill, w_{z}′. Thus, to minimize the objective function of Equation 1 based on the job transition graph, the job-skill generator 206 minimizes the objective function based on affinity scores between skills identified in the skill re-occurrence graph.

With respect to Equation 6, O^{js} represents an objective function that is minimized and corresponds with the job-skill graph. Further, D^{js} represents a set of training triplets sampled from the job-skill graph, G^{js}. [symbol] wₓ_{^{j}},w_{y}_{^{s}}′ [symbol] represents an affinity score between a first job title, wₓ_{^{j}}, and a first skill, w_{y}_{^{s}}′. [symbol] wₓ_{^{j}},w_{z}_{^{s}}′ [symbol] represents an affinity score between the first job title, wₓ_{^{j}}, and a second skill, w_{z}_{^{s}}′. Thus, to minimize the objective function of Equation 1 based on the job-skill graph, the job-skill generator 206 minimizes the objective function based on affinity scores between job titles and skills identified in the skill re-occurrence graph.

Further, the job-skill generator 206 of the illustrated example stores the jobs matrix in the jobs recommendation database 222 and the skills matrix in the skills recommendation database 224 to enable job titles and skills recommendations to subsequently be retrieved for the candidate 102 and/or other job seekers on demand and in real-time. Additionally or alternatively, the job-skill generator 206 is configured to update the jobs matrix and the skills matrix over time. For example, the job-skill generator 206 updates the graphs intermittently, at predefined intervals (e.g., once a day, once of month, etc.), and/or at predefined events (e.g., when the graph generator 204 updates the graphs) to ensure that career path recommendations are being provided to the candidate 102 and/or other job seekers based on up-to-date employment data.

In some examples, the job-skill generator 206 is configured to generate a postings matrix that enables particular job postings to be recommended to the candidate 102 and/or other job seekers. For instance, job postings with a shared job title may correspond with different skill sets at different companies and/or within different industries. The postings matrix includes posting similarity information that indicates how similar particular job postings are with respect to each other. For example, the postings matrix identifies recommendation rankings of job postings that quantitatively indicate to what extent job postings correspond with others within a career path. The recommendation rankings include individual ranks and/or ranking groups. For example, the recommendation rankings include individual ranks, such as a 1st highest rank, a 2nd highest rank, a 3rd highest rank, etc. Additionally or alternatively, the recommendation rankings include ranking groups such as tertiles, quartiles, quintiles, etc.

In the illustrated example, the job-skill generator 206 determines the postings matrix based on the jobs matrix and the skills matrix. For example, the job-skill generator 206 retrofits the jobs matrix and the skills matrix together to enable entries or vectors within the postings matrix to correspond with particular job postings. The job-skill generator 206 retrofits the jobs matrix and the skills matrix together such that each job title of a particular entry or vector within the jobs matrix is modified by one or more corresponding skills of entries or vectors within the skills matrix. For a particular job posting of an entry or vector of the postings matrix, the vector within the jobs matrix that corresponds with the job title of the job posting is modified by vectors within the skills matrix that correspond with skills identified within the job posting. For example, the job-skill generator 206 utilizes Equations 7 and 8 provided below to determine the postings matrix based on the jobs matrix and the skills matrix:

$$\begin{matrix}{w}^{″ i} = \frac{n \cdot {w}^{i} + Σ {w}^{′}}{2 n} & Equation 7 \\ {W}^{″} = {[ {w}_{1}^{″ T} , {w}_{2}^{″ T} , … , {w}_{{n}^{p}}^{″ T} ]}^{T} ϵ {R}^{{n}^{p} \times k} & Equation 8\end{matrix}$$

In Equation 7, w″ⁱ represents the i^{th} job posting within the postings matrix, W″; wⁱ represents the job title within the jobs matrix, W, that corresponds with the i^{th} job posting; and w′ⁱ represents the skills within the skills matrix, W′, that correspond with the i^{th} job posting. In Equation 8, W″ represents the postings matrix, and w″ⁱ represents the i^{th} posting within the postings matrix.

The job-skill generator 206 of the illustrated example also is configured to store the postings matrix in the postings recommendation database 228 to enable job postings recommendations to subsequently be retrieved for the candidate 102 and/or other job seekers on demand and in real-time. Additionally or alternatively, the job-skill generator 206 is configured to update the postings matrix over time. For example, the job-skill generator 206 updates the graphs intermittently, at predefined intervals (e.g., once a day, once of month, etc.), and/or at predefined events (e.g., when the graph generator 204 updates the graphs, when a new job posting is added to the employment website) to ensure that career path recommendations are being provided to the candidate 102 and/or other job seekers based on up-to-date employment data.

Further, in some examples, the job-skill generator 206 is configured to generate a personalized location matrix and a personalized postings matrix that enables career path recommendations for particular job postings to be recommended to a particular candidate (e.g., the candidate 102) based on an address (e.g., a home address, a current work address) of the candidate 102. For example, the job-skill generator 206 is configured to determine a personalized location matrix for a particular candidate that identifies relative distances between the current home or work address of the candidate and office or work locations associated with the job postings. The personalized location matrix generated by the job-skill generator 206 is represented by Equations 9-13 provided below:

R=(X,Y,Z) Equation 9

rⁱ=(xⁱ,yⁱ,zⁱ) Equation 10

x=cos θ×cos φ Equation 11

y=cos θx sin φ Equation 12

z=sin θ Equation 13

In Equation 9, R represents a location matrix, X represents coordinates along an x-axis, Y represents coordinates along a y-axis, and Z represents coordinates along a z-axis. In Equation 10, rⁱ represents the relative coordinates within the location matrix, R, between an address of the candidate and a location associated with the i^{th} job posting within the jobs matrix, W″. Further, xⁱ represents a coordinate of relative coordinates, rⁱ, along an x-axis; yⁱ represents a coordinate of relative coordinates, rⁱ, along a y-axis; and zⁱ represents a coordinate of relative coordinates, rⁱ, along a z-axis. In Equations 11-13, θ represents a relative latitude between an address of the candidate and a location associated with a job posting, and φ represents a relative longitude between an address of the candidate and a location associated with a job posting.

Further, the job-skill generator 206 is configured to determine a personalized postings matrix for a particular candidate that accounts for a proximity of a current address of the particular candidate (e.g., a home address, a work address) to work and/or office locations of the job postings when ranking job postings for the candidate. That is, the closer a work and/or office location of a job posting is to an address of a candidate, the more likely the job-skill generator 206 is in recommending that job posting to that candidate. For example, the job-skill generator 206 is configured to personalize the postings matrix for a particular candidate by concatenating the postings matrix with the personalized location matrix of the candidate. The concatenation of the postings matrix with a personalized location matrix by the job-skill generator 206 is represented by Equation 14 provided below:

W′″=[W″,R] Equation 14

In Equation 14, W′″ represents the postings matrix personalized for a candidate, W″ represents the postings matrix in its non-personalized form, and R represents the personalized location matrix of the candidate. Further, the job-skill generator 206 of the illustrated example is configured to store the postings matrix personalized for a particular candidate in the postings recommendation database 228 to enable job postings recommendations to subsequently be retrieved for that candidate on demand and in real-time. That is, for a particular candidate, posting recommendations are retrieved from the postings matrix (e.g., by the job-skill recommender 210) that is stored in the postings recommendation database 228 upon the job-skill generator 206 personalizing the postings matrix for the candidate. Additionally or alternatively, the job-skill generator 206 is configured to update the postings matrix over time to ensure that career path recommendations are being provided to the particular candidate based on up-to-date employment and candidate data.

The app manager 208 of the illustrated example is configured to control, at least partially, operation of the employment app 104 by collecting, processing, and providing information to the employment app 104 via the network 110. For example, the app manager 208 is configured to receive a current job position of the candidate 102 via the employment app 104. For example, the app manager 208 receives the current job position and address (e.g., a home address, a current work address) from the employment app 104 after the candidate 102 provides his or her current job position and address to the employment app 104 via input device(s) of the computing device (e.g., the touchscreen 106 of the mobile device 108).

Additionally, the app manager 208 is configured to present next-job-title recommendations, posting recommendations, and/or corresponding skills recommendations to the candidate 102 via the employment app 104. In some examples, the app manager 208 is configured to present next-job-title and/or posting recommendations one at a time via the employment app. For example, when the app manager 208 is presenting one of the next-job-title or posting recommendations to the candidate 102 via the employment app 104, the app manager also presents only those skills recommendations that correspond with the next-job-title or posting recommendation being presented. Further, in such examples, the app manager 208 is configured to adjust which one of the next-job-title or posting recommendations (as well as the corresponding skills suggestions) is being presented in response to an input device of the computing device (e.g., the touchscreen 106 of the mobile device 108) receiving an input to do so from the candidate 102. For example, the app manager 208 adjusts which of the next-job-title or posting recommendations is being presented via the touchscreen 106 when the candidate 102 provides a swipe motion across the touchscreen 106.

The job-skill recommender 210 of the illustrated example is configured to retrieve the next-job-title recommendations from the jobs matrix, the posting recommendations from the postings matrix, and/or the jobs recommendation database 222 based on the current job position received by the app manager 208 from the candidate 102. For example, upon retrieving the next-job-title recommendations, the job-skill recommender 210 provides the next-job-title recommendations to the app manager 208 for presentation to the candidate 102 via the employment app 104. Similarly, upon retrieving the posting recommendations, the job-skill recommender 210 provides the posting recommendations to the app manager 208 for presentation to the candidate 102 via the employment app 104. Further, the job-skill recommender 210 of the illustrated example is configured to retrieve the skills recommendations from the skills matrix and/or the skills recommendation database 224 based on the current job position received by the app manager 208 from (i) the candidate 102 and/or (ii) the retrieved next-job-title or posting recommendations. Upon retrieving the skills recommendations, the job-skill recommender 210 provides the skills recommendations to the app manager 208 for presentation to the candidate 102 via the employment app 104.

In some examples, the skills recommendations presented to the candidate 102 via the employment app 104 is user-selectable. For example, the employment app 104 presents one or more of the skills recommendations as respective selectable pushbutton(s). When the candidate 102 selects one of the pushbutton(s) (e.g., via the touchscreen 106 of the mobile device 108), the app manager 208 is configured to receive the selection of the corresponding one of the skills suggestions from the candidate 102 via the employment app 104. Upon receiving a selection of a recommended skill, the app manager 208 provides the selected recommended skill to the skills trainer 212. Further, the skills trainer 212 is configured to retrieve one or more training activities from the training database 226 based on the selected recommended skill. For example, training activities stored in the training database 226 include videos, articles, slide presentations, lesson plans, and/or any other type of material that would enable the candidate 102 and/or other job seekers to learn about and obtain skills for employment. After retrieving a training activity from the training database 226, the skills trainer 212 provides the training activity to the app manager 208. Subsequently, the app manager 208 performs and/or otherwise presents the training activity to the candidate 102 to enable the candidate to learn about and/or obtain the selected recommended skill.

Further, in some examples, the app manager 208 is configured to present a quiz to the candidate 102 via the employment app 104 after the training activity has been completed by the candidate 102. For example, the skills trainer 212 retrieves the quiz from the training database 226, and the app manager 208 presents the quiz retrieved by the skills trainer 212. If the candidate 102 passes the quiz, the app manager 208 is configured to generate a skills addendum for the resume of the candidate 102. For example, the app manager 208 provides the skills addendum to the database manager 202, and the database manager 202 stores the skills addendum with the resume of the candidate 102 for retrieval at a later time when the candidate 102 is applying for a position via the employment app 104.

Additionally or alternatively, the database manager 202, the graph generator 204, the job-skill generator 206, and the job-skill recommender 210 are configured to recommend candidates to the recruiter 116 and/or another recruiter associated with a particular job posting. For example, to facilitate candidate recommendations for the recruiter 116, the database manager 202 collects resumes of candidates. The graph generator 204 generates a job transition graph, a job-skill graph, and a skill re-occurrence based on text extracted from the resumes of the candidates. Further, the job-skill generator 206 is configured to generate a jobs matrix that that indicates how similar job titles are with respect to each other. The job-skill recommender 210 is to identify related titles based on the title of the job posting associated with the recruiter. Based on the recommended related titles, the job-skill recommender 210 also is to recommend candidates who currently have and/or recently had the related job titles. By recommending candidates with related titles to that of the job posting of the recruiter, the job-skill recommender 210 enables the recruiter to identify candidates who can take the next step in their career by applying for the corresponding position of the job posting.

FIG. 3 is a block diagram of electronic components 300 of the employment website entity 100. As illustrated in FIG. 3, the electronic components 300 include one or more processors 302 (also referred to as microcontroller unit(s) and controller(s)). Further, the electronic components 300 include memory 304, input device(s) 306, output device(s) 308, the resume database 214, the job transition database 216, the job-skill database 218, the skill re-occurrence database 220, the jobs recommendation database 222, the skills recommendation database 224, and the training database 226. In the illustrated example, each of the job transition database 216, the job-skill database 218, the skill re-occurrence database 220, the jobs recommendation database 222, the skills recommendation database 224, the training database 226, and the postings recommendation database 228 is a separate database. In other examples, two or more of the job transition database 216, the job-skill database 218, the skill re-occurrence database 220, the jobs recommendation database 222, the skills recommendation database 224, the training database 226, and the postings recommendation database 228 are integrally formed. For example, the job transition database 216, the job-skill database 218, and the skill re-occurrence database 220 may be integrally formed into a single database. Additionally or alternatively, the jobs recommendation database 222, the postings recommendation database 228, and the skills recommendation database 224 may be integrally formed into a single database.

In the illustrated example, the processor(s) 302 are structured to include the database manager 202, the graph generator 204, the job-skill generator 206, the app manager 208, the job-skill recommender 210, and the skills trainer 212. The processor(s) 302 of the illustrated example include any suitable processing device or set of processing devices such as, but not limited to, a microprocessor, a microcontroller-based platform, an integrated circuit, one or more field programmable gate arrays (FPGAs), and/or one or more application-specific integrated circuits (ASICs). Further, the memory 304 is, for example, volatile memory (e.g., RAM including non-volatile RAM, magnetic RAM, ferroelectric RAM, etc.), non-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc.). In some examples, the memory 304 includes multiple kinds of memory, such as volatile memory and non-volatile memory.

The memory 304 is computer readable media on which one or more sets of instructions, such as the software for operating the methods of the present disclosure, can be embedded. The instructions may embody one or more of the methods or logic as described herein. For example, the instructions reside completely, or at least partially, within any one or more of the memory 304, the computer readable medium, and/or within the processor(s) 302 during execution of the instructions.

The terms “non-transitory computer-readable medium” and “computer-readable medium” include a single medium or multiple media, such as a centralized or distributed database, and/or associated caches and servers that store one or more sets of instructions. Further, the terms “non-transitory computer-readable medium” and “computer-readable medium” include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

In the illustrated example, the input device(s) 306 enable a user, such as an information technician of the employment website entity 100, to provide instructions, commands, and/or data to the processor(s) 302. Examples of the input device(s) 306 include one or more of a button, a control knob, an instrument panel, a touch screen, a touchpad, a keyboard, a mouse, a speech recognition system, etc.

The output device(s) 308 of the illustrated example display output information and/or data of the processor(s) 302 to a user, such as an information technician of the employment website entity 100. Examples of the output device(s) 308 include a liquid crystal display (LCD), an organic light emitting diode (OLED) display, a flat panel display, a solid state display, and/or any other device that visually presents information to a user. Additionally or alternatively, the output device(s) 308 may include one or more speakers and/or any other device(s) that provide audio signals for a user. Further, the output device(s) 308 may provide other types of output information, such as haptic signals.

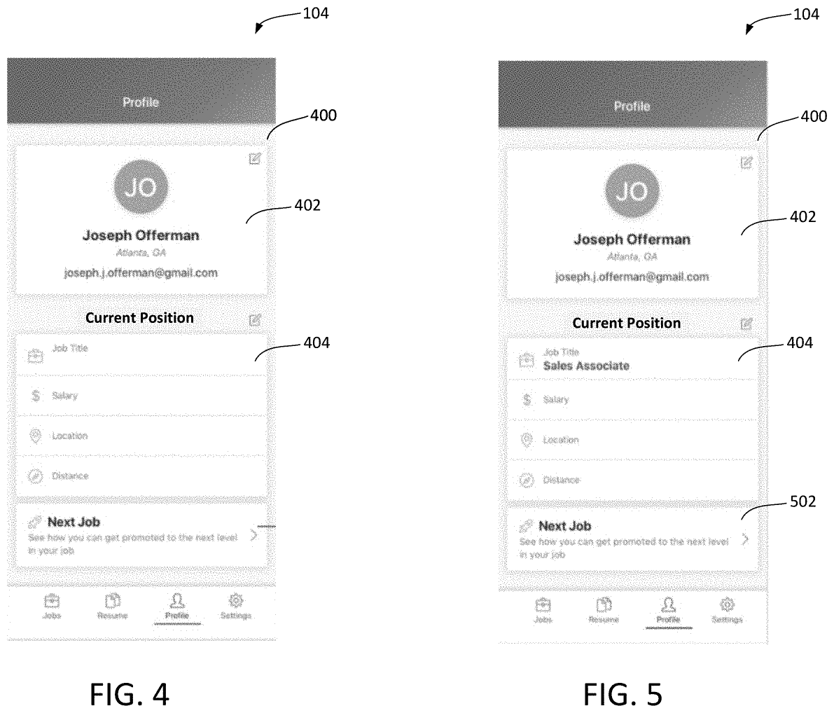

FIGS. 4-13 depict example interfaces of the employment app 104. The example interfaces are configured to be presented via the touchscreen 106 of the mobile device 108 and/or other displays(s) (e.g., a touchscreen, a non-touch display, etc.) of other computing device(s) (e.g., a desktop, a laptop, a tablet, etc.). For example, the interfaces are particularly structured, individually and in conjunction with each other, to present information for job, skills, and training recommendations in an easy-to-follow manner that enables the candidate 102 to facilitate a job-seeker in identifying and becoming qualified for a next job in his or her career path.

FIG. 4 illustrates an example profile interface 400 of the employment app 104. The profile interface 400 is configured collect and present user profile information of the candidate 102. For example, the profile interface 400 of the employment app 104 includes a candidate profile block 402 that includes general information about the candidate 102, such as a name, a location, an email address, etc. Further, the profile interface 400 includes a current position block 404 that enables the candidate 102 to provide information regarding his or her current job position. In the illustrated example, the current position block 404 includes (i) a textbox that enables the employment app 104 to receive a job title of the current job position from the candidate 102, (ii) a textbox that enables the employment app 104 to receive a salary of the current job position from the candidate 102, (iii) a textbox that enables the employment app 104 to receive a location of the current job position from the candidate 102, and (iv) a textbox that enables the employment app 104 to receive a commute distance of the candidate 102 to the current job position from the candidate 102. In other examples, the profile interface 400 includes other types of input field(s) and/or button(s), such as drop-down menu(s), pushbutton(s), toggle(s), slide bar(s), etc. to enable the employment app 104 to receive input information from the candidate 102. Further, the app manager 208 receives the information input by the candidate 102 from the employment app 104.

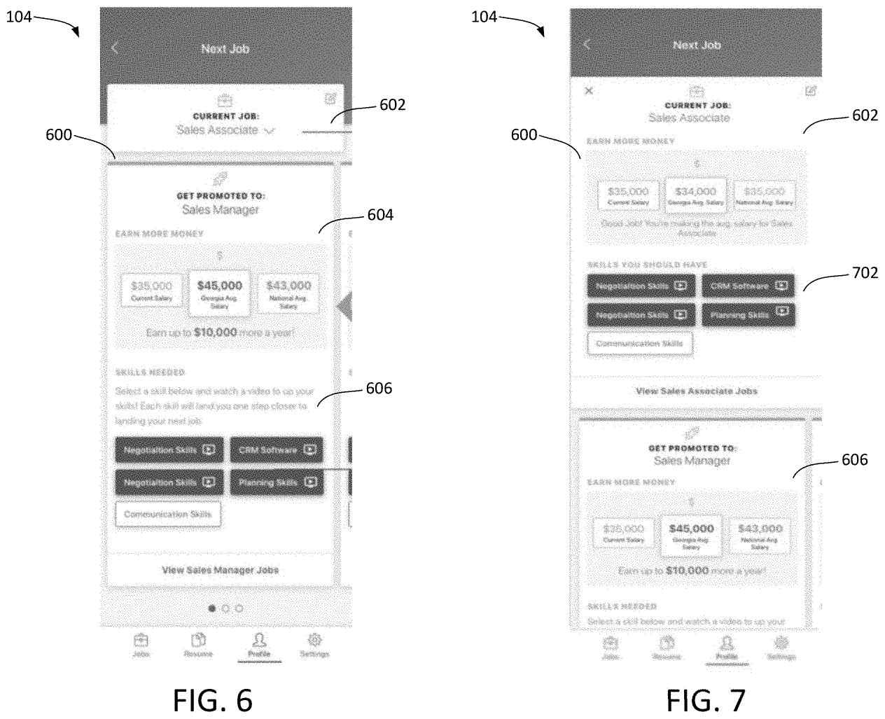

FIG. 5 further illustrates the profile interface 400 after the candidate 102 has provided his or her current position (e.g., “sales associate”) in the corresponding field of the current position block 404. In the illustrated example, the profile interface 400 also includes a next-job pushbutton 502. The employment app 104 receives a command to search for and provide career path recommendations (e.g., next-job-title recommendations, posting recommendations, skills recommendations, training activity recommendations, etc.) in response to the candidate 102 selecting the next-job pushbutton 502. For example, if the candidate 102 presses the next-job pushbutton 502 after providing information for his or her current job position in the input field(s) of the current position block 404, the employment app 104 receives a command for the employment website entity 100 to search for and provide career path recommendations for the candidate 102 based on the current job position of the candidate 102. Upon receiving the selection of the next-job pushbutton 502, the employment app 104 causes another interface (e.g., a next-job interface 600 of FIGS. 6-7) to be presented.

Further, the app manager 208 receives the current job position information, the career path recommendation request, and/or other input information of the candidate 102 from the employment app 104. For example, the app manager 208 instructs the job-skill recommender 210 to identify next-job-title or posting recommendations and corresponding skills recommendations from the jobs recommendation database 222 and the skills recommendation database 224, respectively, for the candidate 102 based on the current job position information provided via the current position block 404 of the profile interface 400.

FIG. 6 illustrates an example next-job interface 600 of the employment app 104. The next-job interface 600 is configured to present career path recommendations to the candidate 102. For example, the next-job interface 600 of the employment app 104 includes a current job block 602. As illustrated in FIG. 6, the current job block 602 presents information (e.g., a job title) of the current job position of the candidate 102. In the illustrated example, the current job block 602 includes an expansion pushbutton (represented by “v” in FIG. 6). Upon detecting that the candidate 102 has selected the expansion pushbutton, the employment app 104 causes the current job block 602 to expand (i.e., increase in size) and present additional information regarding the current job position of the candidate 102. For example, the app manager 208 provides the current job position information to the employment app 104 for presentation via the next-job interface 600.

The next-job interface 600 of the illustrated example also includes a next-job block 604. As illustrated in FIG. 6, the next-job block 604 includes information regarding one or more recommended next job titles (e.g., Get Promoted to: Sales Manager”). In the illustrated example, the next-job interface 600 of the employment app 104 is configured to present a next-job-title recommendation one at a time. For example, the recommended next-job title presented via the next-job interface 600 corresponds with one of a plurality of the next-job-title recommendations that the job-skill recommender 210 retrieves from the jobs recommendation database 222 and provides to the app manager 208 for presentation via the employment app 104. To view another of the next-job-title recommendations retrieved by the job-skill recommender 210, the candidate 102 provides a swipe motion (e.g., from right to left) across the next-job interface 600. For example, the candidate 102 swipes his or her finger and/or a stylus across the touchscreen 106 of the mobile device 108 to instruct the employment app 104 to present a different next-job recommendation.

The next-job block 604 of the illustrated example also includes information that compares the recommended next-job title to the current job position of the candidate 102. For example, the next-job information of the next-job block 604 includes an average salary of the recommended next-job title and a comparison of that average to the current salary of the current job position of the candidate 102.

Additionally, the next-job block 604 of the illustrated example includes a recommended skills section 606 that presents recommended skills for the corresponding recommended next-job title being presented. The recommended skills correspond with skills that enable the candidate 102 to transition from his or her current job position to the recommended next-job title being presented. For example, the recommended skills presented in the recommended skills section 606 corresponds with skills that the candidate 102 likely does not have based on his or her current job position and/or other employment history information. That is, the recommended skills correspond with skills that are associated with the recommended next-job title but not associated with the current job position of the candidate 102. In the illustrated example, the recommended skills correspond with a plurality of the skills recommendations that the job-skill recommender 210 retrieves from the skills recommendation database 224 and provides to the app manager 208 for presentation via the employment app 104. For example, the job-skill recommender 210 identifies skills associated with the corresponding recommended next-job title that the candidate 102 likely does not have based on his or her current job position.

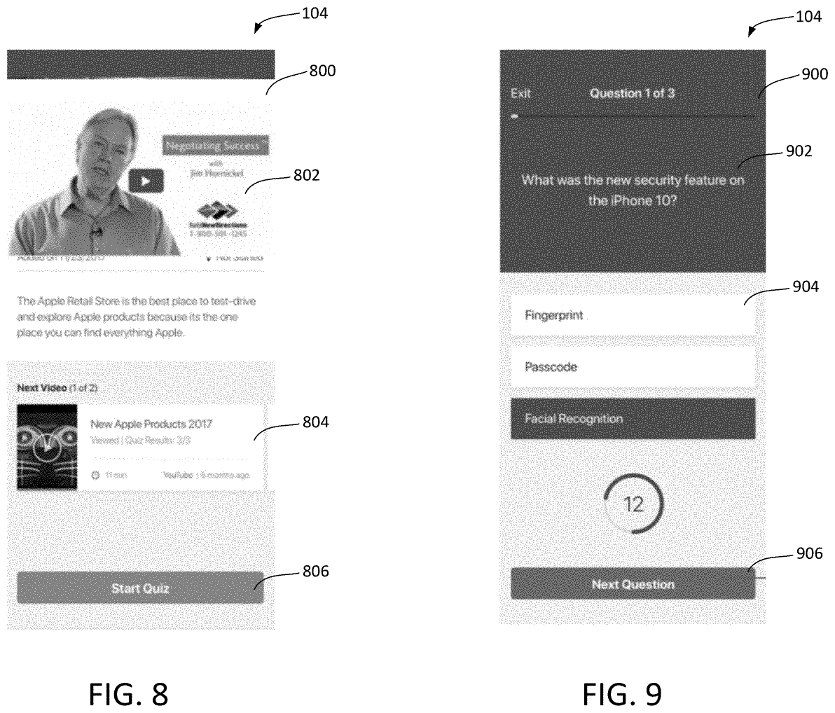

Further, as illustrated in FIG. 6, one or more of the recommended skills may be presented as a selected pushbutton. In the illustrated example, the skills recommendations that correspond with a pushbutton are identified by a corresponding monitor icon next to the recommended skill. Those skills recommendations that do not correspond with a pushbutton do not have a monitor icon. In response to the candidate 102 selecting one of the skill recommendation buttons, the employment app 104 presents another interface (e.g., a training interface 800 of FIG. 8) with training material related to the selected skill.

FIG. 7 further illustrates the next-job interface 600 after the current job block 602 has been expanded. For example, the employment app 104 expands the current job block 602 of the next job interface 600 after the candidate has selected the expansion pushbutton of the current job block 602. In the illustrated example, the current job block 602 is expanded to present additional information related to the current job position of the candidate 102. For example, the additional information includes salary information (e.g., the current salary of the candidate 102, the regional average salary for the job title, the national average salary for the job title, etc.) and/or skills identified as being associated with the job title.

In the illustrated example, the identified skills correspond with a plurality of the skills recommendations that the job-skill recommender 210 retrieves from the skills recommendation database 224 and provides to the app manager 208 for presentation via the employment app 104. For example, the job-skill recommender 210 identifies skills associated with the corresponding recommended next-job title that the candidate 102 should have based on his or her current job position. Further, one or more of the identified skills of the illustrated example are presented as a selected pushbutton (e.g., identified by a corresponding monitor icon). In response to the candidate 102 selecting one of those buttons, the employment app 104 presents another interface (e.g., a training interface 800 of FIG. 8) with training material related to the selected skill.

Alternatively, the app manager 208 presents a posting interface of the employment app 104 that presents job posting recommendations to the candidate 102 based on his or her current position, address, and/or other candidate information. For example, a posting interface of the employment app 104 is configured to present a posting recommendation one at a time. The recommended posting presented via the posting interface corresponds with one of a plurality of the posting recommendations that the job-skill recommender 210 retrieves from the postings recommendation database 228 and provides to the app manager 208 for presentation. To view another of the posting recommendations retrieved by the job-skill recommender 210, the candidate 102 provides a swipe motion (e.g., from right to left) across the posting interface. Further, in some examples, the posting interface includes information that compares the recommended posting to the current job position of the candidate 102. Additionally or alternatively, the posting interface presents recommended skills for the corresponding recommended posting being presented. For example, the recommended skills are skills that (1) the candidate 102 likely does not have based on his or her current job position and/or other employment history information and, thus, (2) enable the candidate 102 to transition from his or her current job position to the corresponding recommended posting. That is, the job-skill recommender 210 is configured to retrieve recommended skills that the app manager 208 is to present to facilitate the candidate 102 in transitioning from his or her current position to the presented recommended job posting.

FIG. 8 illustrates an example training interface 800 of the employment app 104. The training interface 800 includes a training activity 802 that enables the candidate 102 to learn about and/or obtain a skill related to a particular job title or posting. In the illustrated example, the training activity 802 is a video (e.g., an embedded video) that the employment app 104 present in response to candidate 102 selecting a corresponding “play” button. In the illustrated example, the training activity 802 is retrieved by the skills trainer 212 from the training database 226 and provided to the app manager 208 for presentation via the employment app 104 in response to candidate selecting the corresponding button of the next-job interface 600.

In the illustrated example, the training interface 800 also includes another training activity 804 and a quiz pushbutton 806. For example, the training activity 804 corresponds with the skill addressed in the training activity 802 and/or another skill related to the skill addressed in the training activity 802. The training activity 804 is retrieved by the skills trainer 212 from the training database 226 and provided to the app manager 208 for presentation via the employment app 104. Further, the quiz pushbutton 806 is configured to initiate a quiz that tests the candidate 102 on the information presented by the training activity 802. In some examples, the quiz pushbutton 806 only becomes selectable once the candidate 102 completes the training activity 802 (e.g., finishes a video). In response to the candidate 102 selecting the quiz pushbutton 806, the employment app 104 presents another interface (e.g., a quiz interface 900 of FIG. 9) with quiz material related to the training activity 802.

FIG. 9 illustrates an example quiz interface 900 of the employment app 104. The quiz interface 900 presents a quiz to the candidate 102 to determine whether the candidate 102 has obtained the skill corresponding with the training activity 802 of the training interface 800. In the illustrated example, the quiz interface 900 includes a question 902, answer pushbuttons 904, and a next-question pushbutton 906. The quiz (including the questions and the corresponding answers) is retrieved by the skills trainer 212 from the training database 226 and provided to the app manager 208 for presentation via the employment app 104. In the illustrated example, each of the answer pushbuttons 904 corresponds with a respective one of the multiple-choice answers to the question 902. Additionally, in the illustrated example, the quiz interface 900 identifies how many questions are included in the quiz (e.g., 3 questions), which one of the questions is currently being presented (e.g., question 1), and a timer for answering the question 902. Once the candidate 102 has selected one of the answer pushbuttons 904, the candidate 102 is to select the next-question pushbutton 906 to instruct the employment app 104 to present another one of the questions of the quiz. In some examples, the next-question pushbutton 906 only becomes selectable once the candidate 102 has selected one of the answer pushbuttons 904 and/or the timer has timed out. In response to the candidate 102 selecting the next-question pushbutton 906, the employment app 104 presents another question of the quiz until no other questions remain.

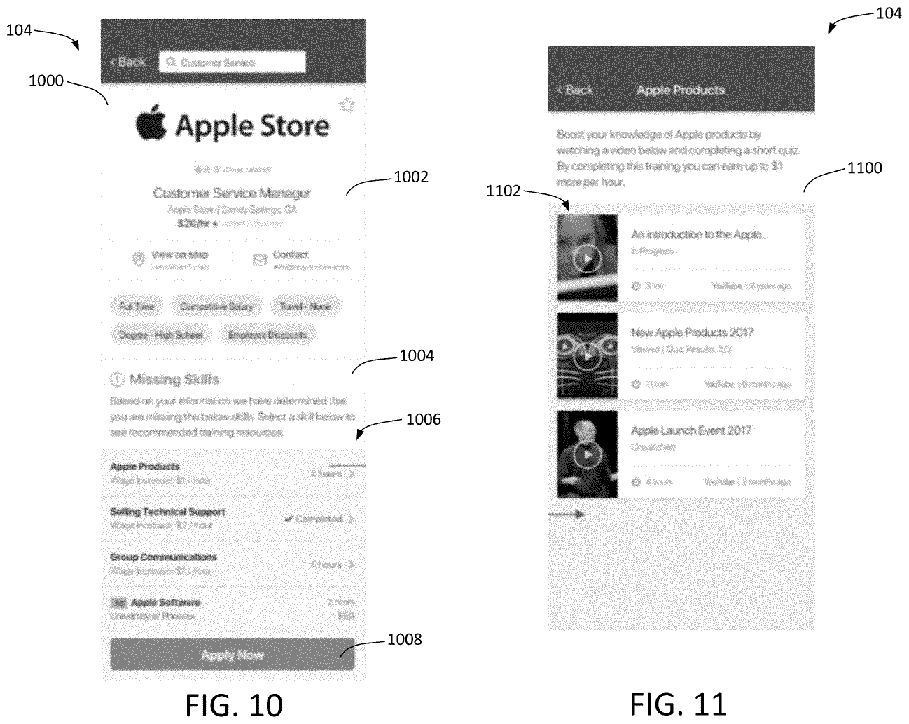

FIG. 10 illustrates an example posting interface 1000 of the employment app 104. As illustrated in FIG. 1000, the posting interface 1000 includes a job description block 1002 and a skills block 1004. For example, the employment app 104 presents the posting interface 1000 to the candidate 102 in response to selecting a corresponding job posting (e.g., for a Customer Service Manager position at the Apple Store in Sandy Springs, Ga.) while searching for potential employment opportunities via the employment app 104.

The job description block 1002 includes information describing the potential employment opportunity of the job posting. For example, the information included within the job description block 1002 identifies an employer (e.g., Apple Store), a job title, (e.g., Customer Service Manager), a location (e.g., Sandy Springs, Ga.), an income level (e.g., $20.00 per hour), a posting status (e.g., posted 2 days ago), commuting information (e.g., less than 1 mile), contact information (e.g., a phone number, an email address, etc.), an employment type (e.g., full time), educational requirements (e.g., high school degree), and/or other characteristics (e.g., competitive salary, no travel, employee discounts, etc.).

The skills block 1004 presents recommended skills for the employment opportunity of the selected job posting. The recommended skills correspond with skills that enable the candidate 102 to transition from his or her current job position to the employment opportunity of the selected job posting. For example, the recommended skills presented in the skills block 1004 corresponds with skills that the candidate 102 likely does not have based on his or her current job position and/or other employment history information. That is, the recommended skills correspond with skills that are associated with the employment opportunity of the selected job posting but not associated with the current job position of the candidate 102. In the illustrated example, the recommended skills correspond with a plurality of the skills recommendations that the job-skill recommender 210 retrieves from the skills recommendation database 224 and provides to the app manager 208 for presentation via the employment app 104. For example, the job-skill recommender 210 identifies skills associated with the employment opportunity of the job posting that the candidate 102 likely does not have based on his or her current job position. Further, as illustrated in FIG. 10, one or more of the recommended skills may be presented as a selected pushbutton (e.g., identified by a monitor icon). In response to the candidate 102 selecting one of the skill recommendation buttons, the employment app 104 presents another interface (e.g., a training interface 1100 of FIG. 11) with training material related to the selected skill. In the illustrated example, the skills block 1004 presents information related to each of the recommended skills. For example, the employment app 104 identifies how long a training activity will take (e.g., 2 hours, 4 hours, etc.), a cost of the training activity (e.g., $50, etc.), a provider of the training activity (e.g., University of Phoenix, etc.), and/or how obtainment of the skill can affect income of the candidate 102 (e.g., a wage increase of $1 per hour, $2 per hour, etc.).

Additionally, the posting interface 1000 includes an apply pushbutton 1008. In response to the candidate 102 selecting the apply pushbutton 1008, the app manager 208 submits a resume of the candidate 102 for the selected job posting. For example, the resume of the candidate 102 is retrieved by the database manager 202 from the resume database 214 and provided to the app manager 208 from submission on behalf of the candidate 102.

FIG. 11 illustrates another example training interface 1100 of the employment app 104. The training interface 1100 includes one or more training activities 1102 that enables the candidate 102 to learn about and/or obtain a skill related to a particular job title and/or posting. In the illustrated example, the training activities 1102 are videos (e.g., an embedded video) that the employment app 104 is configured to present in response to candidate 102 selecting a corresponding “play” button. In the illustrated example, the training activities 1102 are retrieved by the skills trainer 212 from the training database 226 and provided to the app manager 208 for presentation via the employment app 104 in response to candidate selecting a corresponding skill pushbutton on the posting interface 1000.

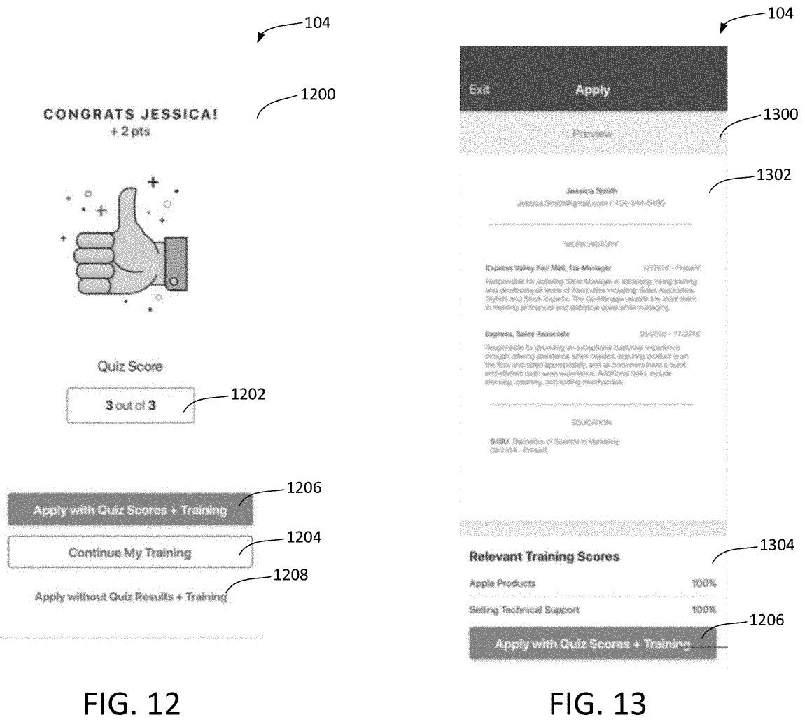

FIG. 12 illustrates another example quiz interface 1200 of the employment app 104. The quiz interface 1200 of the illustrated example is presented by the employment app 104 in response to the candidate 102 completing a quiz after completing a corresponding training activity (e.g., after completing the quiz of the quiz interface 900 for the training activity of the training interface 800). As illustrated in FIG. 12, the quiz interface 1200 includes a quiz score 1202 that the candidate 102 achieved when taking the corresponding quiz. For example, the quiz score 1202 is represented as a percentage, a fraction, etc. In the illustrated example, the quiz score 1202 identifies the number of questions and the number of questions correctly answered (e.g., “3 out of 3”). In some examples, the quiz score 1202 identifies whether the candidate 102 has passed the quiz. For example, the candidate 102 passes a quiz if he or she answers all and/or substantially all (e.g., more than 70%, more than 80%, more than 90%, etc.) of the questions of the quiz correctly. Further, in some examples, the app manager 208 stores the quiz score 1202 of the candidate 102 with a user profile and/or a resume of the candidate 102. For example, the app manager 208 causes the database manager 202 to store the quiz score 1202 with the resume of the candidate 102 in the resume database 214.

Additionally, the quiz interface 1200 of the illustrated example includes a continue-training pushbutton 1204, a first apply pushbutton 1206, and a second apply pushbutton 1208. For example, in response to the candidate 102 selecting the continue-training pushbutton 1204, the employment app 104 presents a training interface (e.g., the training interface 800, the training interface 1100) that enables the candidate 102 to perform other training activities. In response to the candidate 102 selecting the first apply pushbutton 1206 of the employment app 104, the app manager 208 submits the resume of the candidate 102 with a skills addendum corresponding to the skill of the quizzed activity to an employer for a job posting previously selected by the candidate 102 (the job posting previously presented via the posting interface 1000). For example, the app manager 208 generates the skills addendum after the candidate 102 has (1) completed a training activity, (2) completed a corresponding quiz, and (3) passed the corresponding quiz to indicate to potential employers(s) that the candidate 102 has learned about and/or obtained a skill related to its available position identified in a corresponding job posting. Further, the app manager 208 submits the resume of the candidate 102 without a skills addendum for a previously-selected job posting in response to the candidate 102 selecting the second apply pushbutton 1208.

FIG. 13 illustrates an example resume interface 1300 of the employment app 104. In the illustrated example, the resume interface 1300 includes a resume block 1302, a skills block 1304, and the first apply pushbutton 1206. As illustrated in FIG. 13, the resume block 1302 includes a resume of the candidate 102. For example, the resume is retrieved by the database manager 202 from the resume database 214 and provided to the app manager 208 for presentation via the employment app 104. Further, a skills addendum is retrieved by the database manager 202 and provided to the app manager 208 for presentation via the employment app 104. As illustrated in FIG. 13, the employment app 104 includes the skills addendum in the skills block 1304. The skills addendum includes one or more quiz scores of training activities that correspond to skills relevant to a job position of a posting (e.g., a required skill, a suggested skill, a preferred skill, etc.) to which the candidate 102 is applying. In the illustrated example, the skills addendum is a separate document than the resume of the resume of the candidate 102. In other examples, the skills addendum is included within and/or attached to resume of the candidate 102. Further, the app manager 208 submits the resume and the skills addendum of the candidate 102 to the employer associated with the selected job posting in response to the candidate 102 selecting the first apply pushbutton 1206.

The employment app 104 of the illustrated example is configured to receive inputs via digital buttons, textboxes, etc. of the interfaces 400, 600, 700, 800, 900, 1000, 1100, 1200, 1300 tactilely (e.g., via the touchscreen 106, analog buttons, a mouse, a keyboard, etc. of a computing device). Additionally or alternatively, the employment app 104 is configured to receive inputs audibly (e.g., via a microphone and speech-recognition software of a computing device) from the candidate 102.

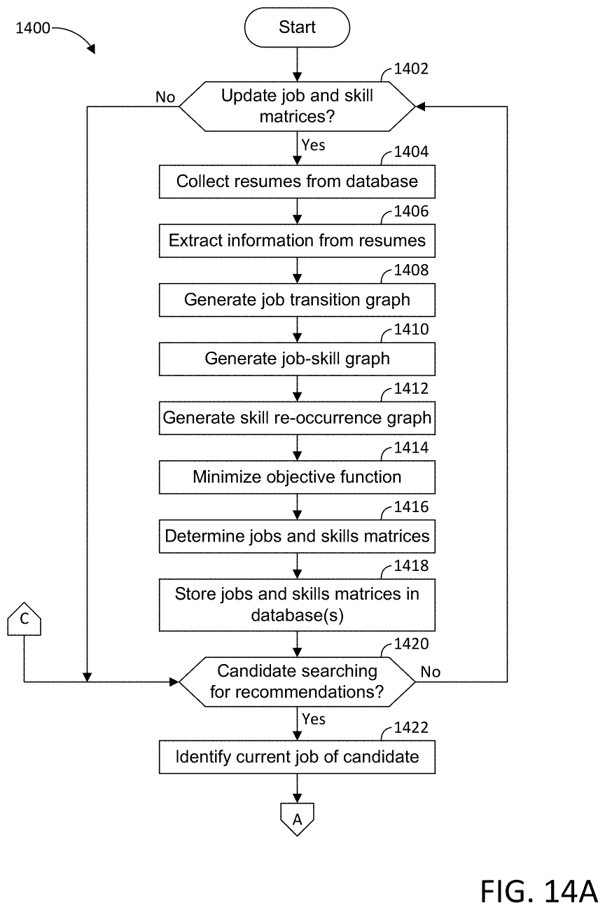

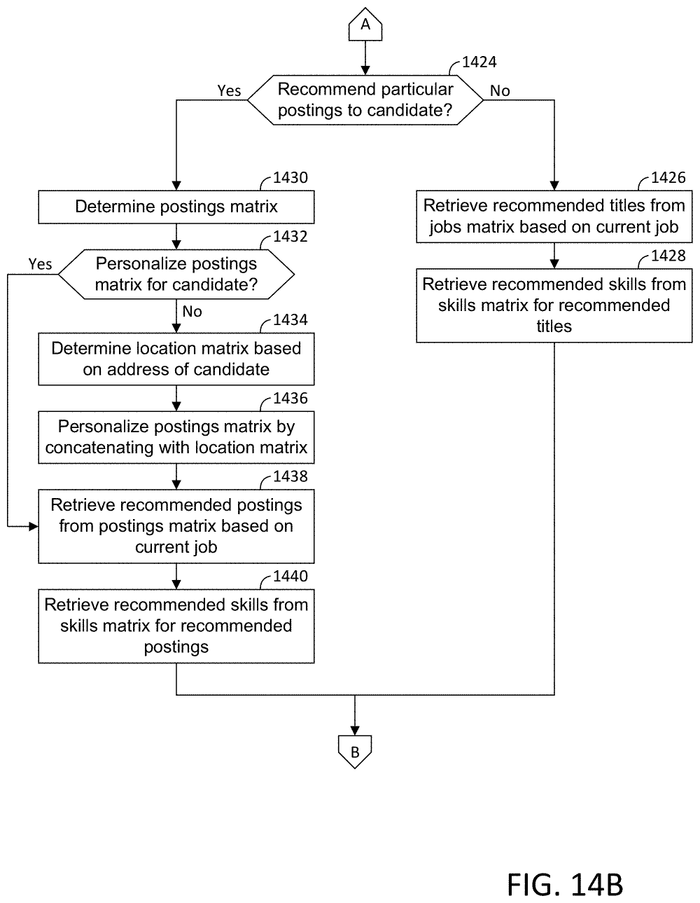

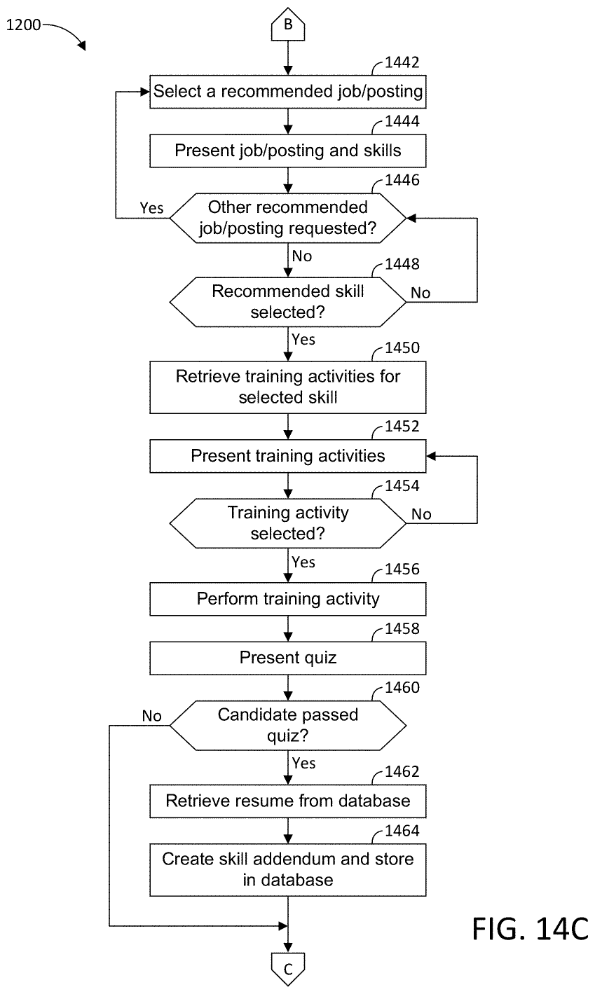

The flowchart of FIGS. 14A-14C is representative of machine readable instructions that are stored in memory (such as the memory 304 of FIG. 3) and include one or more programs which, when executed by one or more processors (such as the one or more processors 302 of FIG. 3), cause the employment website entity 100 to implement the example database manager 202, the example graph generator 204, the example job-skill generator 206, the example app manager 208, the example job-skill recommender 210, and the example skills trainer 212 of FIGS. 2-3. While the example program is described with reference to the flowchart illustrated in FIGS. 14A-14C, many other methods of implementing the example database manager 202, the example graph generator 204, the example job-skill generator 206, the example app manager 208, the example job-skill recommender 210, and the example skills trainer 212 may alternatively be used. For example, the order of execution of the blocks may be rearranged, changed, eliminated, and/or combined to perform the method 1400. Further, because the method 1400 is disclosed in connection with the components of FIGS. 1-13, some functions of those components will not be described in detail below.

Initially, at block 1402, the database manager 202 determines whether it is time to update the jobs matrix of the jobs recommendation database 222 and the skills matrix of the skills recommendation database 224. For example, the database manager 202 determines that it is time to update the jobs and skills matrices intermittently, at predefined intervals, and/or at predefined events. In response to the database manager 202 determining that it is not time to update the jobs and skills matrices, the method 1400 proceeds to block 1420. Otherwise, in response to the database manager 202 determining that it is time to update the jobs and skills matrices, the method 1400 proceeds to block 1404.

At block 1404, the graph generator 204 retrieves resumes stored in the resume database 214. For example, the database manager 202 collects the resumes and stores the resumes in the resume database 214 for subsequent retrieval by the graph generator 204. At block 1406, the graph generator 204 extracts information from the resumes. For example, the job information extracted by the graph generator 204 includes job characteristics, such as title, salary, employer, location, etc. The skill information extracted by the graph generator 204 may include skill types, such as negotiation skills, planning skills, software proficiencies, etc. Further, in some examples, the graph generator 204 utilizes text mining software to extract the job information and the skill information from the resumes.

At block 1408, the graph generator 204 generates a job transition graph, for example, based on the extracted job information. The job transition graph generated by the graph generator 204 identifies how likely job seekers are in transitioning between particular job titles. Further, the graph generator 204 stores the job transition graph in the job transition database 216. At block 1410, the graph generator 204 generates a job-skill graph, for example, based on the extracted job and skill information. The job-skill graph generated by the graph generator 204 identifies how skills are associated with the job titles. Further, the graph generator 204 stores the job-skill graph in the job-skill database 218. At block 1412, the graph generator 204 generates a skill re-occurrence graph, for example, based on the extracted skill information. The skill re-occurrence graph generated by the graph generator 204 identifies which of the skills are associated with each other. Further, the graph generator 204 stores the skill re-occurrence graph in the skill re-occurrence database 220.

At block 1414, the job-skill generator 206 minimizes an objective function (e.g., a sigmoid function, a ReLU function). For example, the job-skill generator 206 minimizes the objective function, such as the above-provided Equation 1, based on, at least in part, the job transition graph, the job-skill graph, and the skill re-occurrence graph. At block 1416, the job-skill generator 206 determines a jobs matrix and a skills matrix based on the minimization of the objective function. For example, the jobs matrix identifies recommendation rankings of job titles that quantitatively indicate to what extent job titles correspond with others within a career path, and the skills matrix identifies recommendation rankings of skills that quantitatively indicate how some skills correspond with other skills and/or with job titles within a career path. The recommendation rankings may include individual ranks (e.g., 1st highest rank, a 2nd highest rank, a 3rd highest rank, etc.) and/or ranking groups (e.g., tertiles, quartiles, quintiles, etc.). In the illustrated example, the job-skill generator 206 utilizes a representation learning model to jointly determine the job similarity information of the jobs matrix and the skill similarity information of the skills matrix in a single, shared k-dimensional latent space by minimizing an objective function based on, at least in part, the job transition graph, the job-skill graph, and the skill re-occurrence graph. At block 1418, the job-skill generator 206 stores (i) the jobs matrix in the jobs recommendation database 222 and (ii) the skills matrix in the skills recommendation database 224.

At block 1420, the app manager 208 determines whether the candidate 102 is searching for employment recommendations via the employment app 104. For example, the app manager 208 determines that the candidate 102 is searching for recommendations if the candidate 102 accesses the profile interface 400 of the employment app 104. In response to the app manager 208 determining that the candidate 102 is not searching for recommendations, the method 1400 returns to block 1402. Otherwise, in response to the app manager 208 determining that the candidate 102 is searching for recommendations, the method 1400 proceeds to block 1422. At block 1422, the app manager 208 identifies a current job position of the candidate 102. For example, the app manager 208 receives the current job position from the employment app 104 after the candidate 102 inputs the current job position into an input field of the profile interface 400.

At block 1424, the job-skill recommender 210 determines whether particular job postings are to be recommended to the candidate 102. In response to the job-skill recommender 210 determining that particular job postings are not to be recommended to the candidate 102, the method 1400 proceeds to block 1426 in order to recommend job titles to the candidate. At block 1426, the job-skill recommender 210 retrieves next-job-title recommendations from the jobs recommendation database 222 based on the current job position that is identified by the app manager 208. At block 1428, the job-skill recommender 210 retrieves skills recommendations from the skills recommendation database 224 for the next-job-title recommendations.

Returning to block 1424, in response to the job-skill recommender 210 determining that particular job postings are to be recommended to the candidate 102, the method 1400 proceeds to block 1430 at which the job-skill generator 206 determines a postings matrix by retrofitting the jobs matrix with the skills matrix such that each job vector within the jobs matrix is modified by one or more corresponding skills vectors within the skills matrix. For example, the postings matrix identifies recommendation rankings of job postings that quantitatively indicate to what extent job postings correspond with others within a career path. The recommendation rankings may include individual ranks (e.g., 1st highest rank, a 2nd highest rank, a 3rd highest rank, etc.) and/or ranking groups (e.g., tertiles, quartiles, quintiles, etc.).

At block 1432, the job-skill recommender 210 determines whether to personalize the postings matrix for the candidate 102. In response to the job-skill recommender 210 determining not to personalize the postings matrix, the method 1400 proceeds to block 1438. Otherwise, in response to the job-skill recommender 210 determining to personalize the postings matrix, the method 1400 proceeds to block 1434 at which the job-skill generator 206 determines a location matrix personalized for the candidate. For example, the job-skill generator 206 identifies relative distances between the current home or work address of the candidate 102 and office and/or work locations associated with the job postings of the postings matrix. At block 1436, the job-skill generator 206 personalizes the postings matrix for the candidate 102 to account for a proximity of the candidate 102 when recommending job postings to the candidate 102. For example, the job-skill generator 206 personalizes the postings matrix for the candidate 102 by concatenating the postings matrix with the personalized location matrix of the candidate 102.

At block 1438, the job-skill recommender 210 retrieves posting recommendations from the postings recommendation database 228 based on the current job position that is identified by the app manager 208. At block 1440, the job-skill recommender 210 retrieves skills recommendations from the skills recommendation database 224 for the posting recommendations.

At block 1442, upon completing block 1428 or block 1442, the app manager 208 selects one of the next-job-title or posting recommendations. For example, the app manager 208 selects the highest ranked next-job-title or posting recommendation. At block 1444, the app manager 208 presents the selected next-job-title or posting recommendation and the corresponding skills recommendations to the candidate 102 via the next-job interface 600 of the employment app 104.

At block 1446, the app manager 208 determines whether the candidate 102 has requested to view another one of the next-job-title or posting recommendations and its corresponding recommended skills. For example, the app manager 208 determines that the candidate 102 has requested to view another one of the next-job-title or posting recommendations in response to the employment app receiving such an input from the candidate 102 (e.g., a left-to-right swiping motion across the touchscreen 106). In response to the app manager 208 determining that the candidate 102 has requested to view another one of the next-job-title posting recommendations, the method 1400 returns to block 1442. Otherwise, in response to the app manager 208 determining that the candidate 102 has not requested to view another one of the next-job-title or posting recommendations, the method 1400 proceeds to block 1448.

At block 1448, the app manager 208 determines whether the candidate 102 has selected one of the recommended skills. For example, the app manager 208 determines that the candidate 102 has selected a recommended skill in response to the candidate selecting a corresponding skill pushbutton of the employment app 104. In response to the app manager 208 determining that the candidate 102 has not selected a recommended skill, the method 1400 returns to block 1446. Otherwise, in response to the app manager 208 determining that the candidate 102 has selected a recommended skill, the method 1400 proceeds to block 1450 at which the skills trainer 212 retrieves one or more training activities from the training database 226 for the selected skill. At block 1452, the app manager 208 presents one or more training activities to the candidate 102 via the employment app 104. At block 1454, the app manager 208 determines whether the candidate 102 has selected one of the training activities. In response to the app manager 208 determining that the candidate 102 has not selected a training activity, the method 1400 returns to block 1452. Otherwise, in response to the app manager 208 determining that the candidate 102 has selected a training activity, the method 1400 proceeds to block 1456.

At block 1456, the app manager 208 causes the employment app 104 to perform the training activity for the candidate 102. For example, the employment app 104 plays a video for the candidate 102. At block 1458, the app manager 208 causes the employment app 104 to present a corresponding quiz to the candidate 102 in response to the candidate 102 completing the training activity. For example, the skills trainer 212 retrieves the quiz from the training database 226 for presentation to the candidate 102. At block 1460, after the candidate 102 has completed the quiz, the app manager 208 determines whether the candidate 102 has passed the quiz. In response to the app manager 208 determining that the candidate 102 has not passed the quiz, the method 1400 returns to block 1420. Otherwise, in response to the app manager 208 determining that the candidate 102 has passed the quiz, the method 1400 proceeds to block 1462 at which the database manager 202 retrieves a resume of the candidate 102 from the resume database 214. At block 1464, the app manager 208 creates a skills addendum identifying that the candidate 102 has obtained and/or otherwise learned about a particular skill. Further, the app manager 208 associates the skill addendum with the resume of the candidate 102, and the database manager 202 stores the resume and the associated skills addendum in the resume database 214. Additionally or alternatively, the app manager 208 submits the resume and skills addendum on behalf of the candidate 102 to an employer with a potential employment opportunity corresponding with a particular job posting.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

The above-described embodiments, and particularly any “preferred” embodiments, are possible examples of implementations and merely set forth for a clear understanding of the principles of the invention. Many variations and modifications may be made to the above-described embodiment(s) without substantially departing from the spirit and principles of the techniques described herein. All modifications are intended to be included herein within the scope of this disclosure and protected by the following claims.

What is claimed is:

1. A system for determining recommendations for career paths, the system comprising:
one or more processors of an employment website entity configured to:
extract job information and skill information from resumes in a resume database;
generate a job transition graph based on the job information, wherein the job transition graph identifies likelihoods of transitioning between job positions;
generate a job-skill graph based on the job information and the skill information, wherein the job-skill graph identifies skills associated with the job positions;
generate a skill re-occurrence graph based on the skill information, wherein the skill re-occurrence graph identifies which of the skills are associated with each other;
determine a jobs matrix by minimizing an objective function based on the job transition graph, the job-skill graph, and the skill re-occurrence graph, wherein the jobs matrix identifies recommendation rankings of the job positions for career paths;
store the jobs matrix in a jobs database;
receive, via an employment app, a current job position of a candidate;
retrieve next-job recommendations from the jobs matrix based on the current job position; and
present, via the employment app, the next-job recommendations for the candidate.

2. The system of claim 1, wherein the one or more processors are configured to:
update the job transition graph, the job-skill graph, and the skill re-occurrence graph at intervals; and
update the jobs matrix when the job transition graph, the job-skill graph, and the skill re-occurrence graph are updated.

3. The system of claim 1, wherein the objective function utilized by the one or more processors is a sigmoid function or a rectifier linear unit function.

4. The system of claim 1, wherein the one or more processors are configured to:
minimize the objective function based on the job transition graph by minimizing the objective function based on affinity scores between the jobs;
minimize the objective function based on the job-skill graph by minimizing the objective function based on affinity scores between the jobs and the skills; and
minimize the objective function based on the skill re-occurrence graph by minimizing the objective function based on affinity scores between the skills.

5. The system of claim 1, wherein the one or more processors are configured to:
determine a skills matrix by minimizing the objective function based on the job transition graph, the job-skill graph, and the skill re-occurrence graph, wherein the skills matrix identifies recommendation rankings of the skills for the career paths; and
store the skills matrix in a skills database.

6. The system of claim 5, wherein the one or more processors are configured to:
retrieve skills recommendations to facilitate the candidate in transitioning from the current job position to the next job recommendations; and
present, via the employment app, the skills recommendations for the candidate.

7. The system of claim 6, wherein the one or more processors minimize the objective function to jointly learn the recommendation rankings of the jobs and the recommendation rankings of the skills in a shared k-dimensional space to increase a relevancy of the next-job recommendations and the skill recommendations for the candidate.

8. The system of claim 6, wherein the one or more processors are configured to:
receive a selection of one of the skills recommendations from the candidate via the employment app;
retrieve a training activity from a training database based on the selected one of the skills recommendations; and
perform the training activity that corresponds with the selected one of the skills recommendations.

9. The system of claim 8, wherein the one or more processors are configured to present a quiz to the candidate via the employment app after the training activity has been completed.

10. The system of claim 9, wherein the one or more processors are configured to generate a skills addendum to a resume of the candidate in response to the candidate passing the quiz.

11. A system for determining recommendations for career paths, the system comprising:
one or more processors of an employment website entity configured to:
extract job information and skill information from resumes in a resume database;
generate a job transition graph based on the job information, wherein the job transition graph identifies likelihoods of transitioning between job titles;
generate a job-skill graph based on the job information and the skill information, wherein the job-skill graph identifies skills associated with the job titles;
generate a skill re-occurrence graph based on the skill information, wherein the skill re-occurrence graph identifies which of the skills are associated with each other;
determine a jobs matrix and a skills matrix by minimizing an objective function based on the job transition graph, the job-skill graph, and the skill re-occurrence graph, wherein the jobs matrix identifies recommendation rankings of the job titles for career paths, wherein the skills matrix identifies recommendation rankings of the skills for the career paths;
determine a postings matrix based on the jobs matrix and the skills matrix, wherein the postings matrix identifies recommendation rankings of job postings for the career paths;
store the postings matrix in a postings recommendation database;
receive, via an employment app, a current job position of a candidate;
retrieve the posting recommendations from the postings matrix based on the current job position; and
present, via the employment app, the posting recommendations for the candidate.

12. The system of claim 11, wherein the one or more processors are configured to:
update the job transition graph, the job-skill graph, and the skill re-occurrence graph at intervals; and
update the jobs matrix, the skills matrix, and the postings matrix when the job transition graph, the job-skill graph, and the skill re-occurrence graph are updated.

13. The system of claim 11, wherein the objective function utilized by the one or more processors is a sigmoid function or a rectifier linear unit function.

14. The system of claim 11, wherein the one or more processors are configured to at least one of:
minimize the objective function based on the job transition graph by minimizing the objective function based on affinity scores between the job titles;
minimize the objective function based on the job-skill graph by minimizing the objective function based on affinity scores between the job titles and the skills; and
minimize the objective function based on the skill re-occurrence graph by minimizing the objective function based on affinity scores between the skills.

15. The system of claim 11, wherein the one or more processors are configured to:
store the skills matrix in a skills database;
retrieve skills recommendations to facilitate the candidate in transitioning from the current job position to the posting recommendations; and
present, via the employment app, the skills recommendations for the candidate.

16. The system of claim 15, wherein the one or more processors are configured to minimize the objective function to jointly learn the recommendation rankings of the job titles and the recommendation rankings of the skills in a shared k-dimensional space to increase a relevancy of recommendations for the candidate.

17. The system of claim 15, wherein the one or more processors are configured to:
receive a selection of one of the skills recommendations from the candidate via the employment app;
retrieve a training activity from a training database based on the selected one of the skills recommendations; and
perform the training activity that corresponds with the selected one of the skills recommendations.

18. The system of claim 15, wherein the one or more processors are configured to:
present a quiz to the candidate via the employment app after the training activity has been completed; and
generate a skills addendum to a resume of the candidate in response to the candidate passing the quiz.

19. The system of claim 11, wherein, to determine the postings matrix based on the jobs matrix and the skills matrix, the one or more processors are configured to retrofit the jobs matrix and the skills matrix together such that each job title vector within the jobs matrix is modified by one or more corresponding skills vectors within the skills matrix.

20. The system of claim 11, wherein the one or more processors are configured to:
determine a personalized location matrix for the candidate that identifies relative distances between locations associated with the job postings and an address of the candidate;
personalize the postings matrix for the candidate by concatenating the location matrix with the postings matrix; and
retrieve the posting recommendations for the candidate upon personalizing the postings matrix for the candidate.
